(19) United States
(12) Patent Application Publication
(10) Pub. No.: US 2021/0329987 A1
(43) Pub. Date: Oct. 28, 2021

(54) FACE MASK

(71) Applicant: Tommye Joyce Austin, Spring Branch, TX (US)

(72) Inventor: Tommye Joyce Austin, San Antionio, TX (US)

(21) Appl. No.: 16/860,917

(22) Filed: Apr. 28, 2020

(51) Int. Cl. A41D 13/11

(52) U.S. Cl. CPC A41D 13/11

(57) ABSTRACT

A face mask is made from five layers of surgical drape, synthetic filtration material having a bacterial filtration effective of 95% and a synthetic MERV-13 filtration material. The five layers are folded and cut on each side at approximately 45 degrees. Front folds provide a pocket for air exchange in the front area of the face mask. Edge folds provide a border and hold a memory strip in place over wearer's nose. The 45 degree sides are sewed together with a border, plus attaching ends of two bungee strips thereto. The first bungee strip extends to the neck area below the head of the wearer and, with a first bungee lock, pulls the face mask into the nose. The second bungee cord strip extends to the top rear of head of the wearer and, with a second bungee lock, pulls the mask under the chin. By pressing the memory strip and tightening the bungee locks, a tight fit is provided on the face mask to the wearer.

### FIELD OF THE INVENTION

This invention relates to a maximum filtration face mask, and, more particularly, to face masks that are worn by individuals for long periods of time who are exposed to airborne diseases such as tuberculosis, influenza, and Covid-19.

### BACKGROUND

There are many different types of face masks that an individual may use based on the level of protection for a procedure or risk level. Masks range between minimum performance to maximum filtration. A minimum performance face mask provides a physical barrier only and has no filtration efficiency. A minimum performance mask is ideal as a simple barrier for exams and visitations for dry, short procedures where there is no risk of fluids, spray or aerosols.

A low performance face mask is a molded utility mask and provides a physical barrier and does not have any significant filtration efficiency. Again, a low performance face mask would not be used in environments that produce fluids, spray or aerosol.

According to ratings by the American Society of Testing and Materials, there are also ASTM Levels 1, 2 and 3 face masks that offer different levels of filtration efficiency. These ASTM Level 1 face masks have low fluid resistance and bacteria filtration efficiency (BFE) of 95% or greater. ASTM Level 1 face masks can be used when low amounts of fluids, spray or aerosols are produced.

ASTM level 2 masks may be used when moderate amounts of fluids, spray or aerosols are produced and has a BFE of 98% or greater.

ASTM level 3 face masks are when heavy amounts of fluid, spray or aerosols are produced and can have a BFE of 98% or greater.

Maximum filtration efficiency masks are particulate respirators that are rated by National Institute of Occupational Health and Safety (NIOSH). Particle respirators or N95 respirator masks have a filtration efficiency rate of 99.95%. The N95 mask is used when a health care worker needs protection from airborne biological agents such as tuberculosis, influenza or COVID-19.

When choosing the right mask an individual should consider filtration, fluid resistance, additional features and fit. Even the right mask, without a good fit, could place the wearer at risk.

The level of filtration necessary in dealing with tuberculosis, influenza or COVID-19 requires a face mask with maximum filtration. However, the volume of air that can be obtained through maximum filtration face masks, such as an N95, can be a problem because the user may not get enough oxygen (hypooxygenation), which can cause carbon dioxide buildup (hypercapnia) build-up and cause the wearer to get a headache, lightheaded, or even pass out. A face mask is needed that has no leakage of air, yet gives the user enough air exchange that there will not be a carbon dioxide buildup within the face mask, while still giving maximum filtration. Other necessary components of a maximum filtration mask include the ability to wear the mask for long periods of time without damaging the skin on the face.

### SUMMARY OF THE INVENTION

It is an object of the present invention to provide a face mask that provides maximum filtration such as a NIOSH approved N95 particulate respirator.

It is another object of the present invention to provide a maximum filtration face mask that can be constructed from layers of filtration materials.

In constructing the present face mask, layers of either tightly woven cotton fabric or surgical drape makes up the inside and outside layers. In between the inside and outside layers of tightly woven cotton fabric or surgical drape are located (a) a layer of synthetic filtration media with a bacterial filtration efficiency (BFE95), (b) synthetic filtration media with a Maximum Efficiency Reporting Value (MERV) of 13 or greater and (c) another layer of BFE95 synthetic filtration media.

The five layers are folded with (a) two folds approximately 1 inch on either side of the center line, and (b) half inch folds on each outer edge from the center line.

After folding, each end is cut at approximately 45 degrees cutting off a portion along the center line. The amount remaining should reach from cheek to cheek of the wearer. The outer edges are sewn together with a metal strip being sewn in the upper half inch fold. The 45 degree edges are sewn together with a bias along the edge. Elastic or bungee cords are connected to the 45 degree edges with one being located below the head and on the neck to pull the face mask into the nose, and the other bungee or elastic cord being located at the top rear of the head to pull the face mask up under the wearer's chin.

In use, the 1 inch folded layers expands so that the wearer has an increased volume for air exchange to reduce carbon dioxide build up. If the bungee cords with cord locks are used, the bungee cords can be tightened as needed by the wearer to obtain the best fit.

Because people have different size heads or other facial features, different sizes of the face mask will be made, such as a small, medium, large or extra-large. The outer corners of the face masks should go from cheek to cheek on the wearer.

In putting on the face mask, the bungee cords, (or elastic) are pulled over the wearer's head. The shorter bungee cord or elastic extends behind the wearer's neck. The long bungee cord or elastic extending to the top of the wearer's head. The metal strip should be over the arch of the wearer's nose. The wearer should expand the pocket in the face mask and crunch down the metal strip to match the arch of the wearer's nose. The mask should be tightened so there is no leakage and fits comfortably. The filtration provided by this type of face mask would be at least as high as an N95 face mask, but normally higher.

### BRIEF DESCRIPTION OF THE DRAWINGS

FIG. 1 is a side environmental view showing a face mask in use.

FIG. 2 is a front view of FIG. 1.

FIG. 3 is an exploded perspective view of component parts of the face mask.

FIG. 4 is five layers of the face mask being folded together with first folds.

FIG. 5 is an end view of FIG. 4.

FIG. 6 is a sequential view from FIG. 4 illustrating the five layers being folded with the second folds.

FIG. 7 is the end view of FIG. 6.

FIG. 8 is a sequential view from FIG. 6 showing two corners after being cut off.

FIG. 9 is a sequential view after FIG. 8 adding hems and bungee cord with cord locks to the face mask.

FIG. 10 is a side view showing shape of the face mask when in use.

### DESCRIPTION OF THE PREFERRED EMBODIMENT

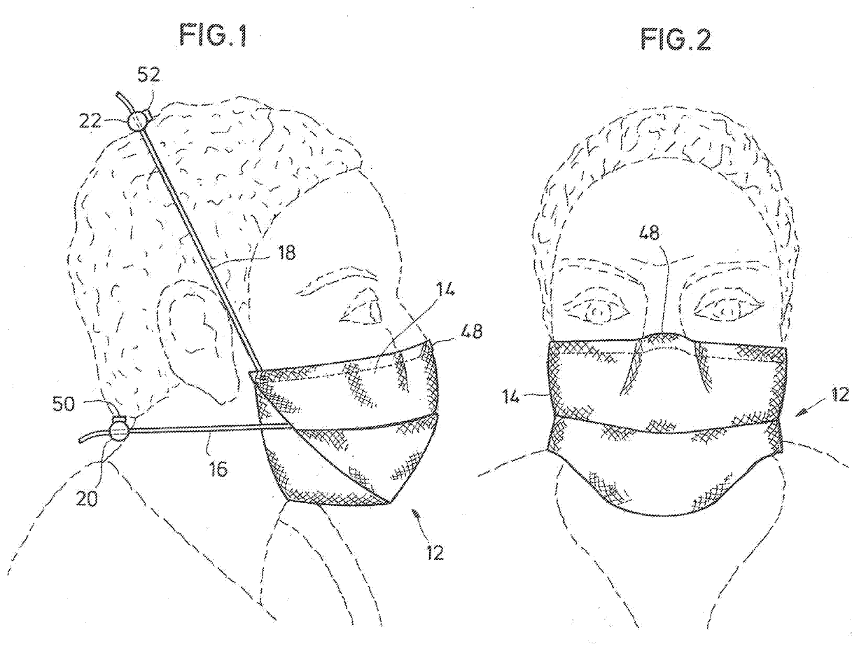

Referring to FIGS. 1 and 2 in combination a face mask 12 is pictorially shown on a wearer in front and side views. The face mask 12 has a face covering portion 14 that is held in place by bungee cords 16 and 18, which bungee cords 16 and 18 may be tightened or loosened by bungee cord locks 20 and 22, respectively. Bungee cord 16 and bungee cord lock 20 pull the face mask 12 into the wearer's face to securely press against the cheeks and nose of the wearer.

Bungee cord 18 and bungee cord lock 22 pulls the face mask 12 to securely pass under the wearer's chin. The bungee cords 16 and 18 with bungee cord lock 20 and 22, respectively, ensure the facial covering portion 14 is pressed against the wearer's face so there is no leakage of expired gases, including any aerosol moisture that may contain contaminates or viruses.

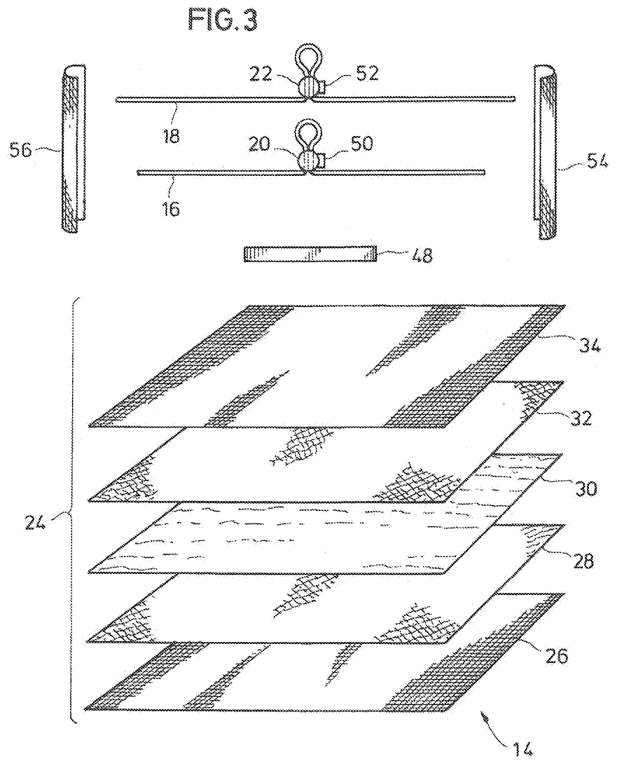

Referring to FIG. 3 an exploded perspective of the facial covering portion 14 of the face mask 12 is shown. The facial covering portion 14 has five layers that are approximately 12 inches by 12 inches. The outermost layer 26 is a surgical drape that is typically made from a woven cotton fabric. The next layer 28 is a synthetic filtration media that has a bacterial filtration efficiency BFE95. BFE is a measurement of a materials resistance to penetration of bacteria and the ability of the fabric to resist bacterial penetration. A typical supplier is Air Filters, Inc. located in Houston, Tex.

The center layer 30 is a MERV 13 filter that is also a synthetic filtration material and also can be obtained from Air Filters, Inc. MERV is an acronym for “maximum efficiency reporting value”, which was developed as a filtration measurement scale by American Society of Heating, Refrigeration and Air Conditioning Engineers (ASHRAE) to report the effectiveness of air filters. MERV 13 material is typically used in hospitals and general surgery to control contaminates such as bacteria, or droplet nuclei caused by sneezing.

The fourth layer 32 is also a synthetic filtration media with a BFE 95 rating, and can be identical to the layer 28.

The inside layer 34 is a woven cotton fabric such as a surgical drape similar to outer layer 26.

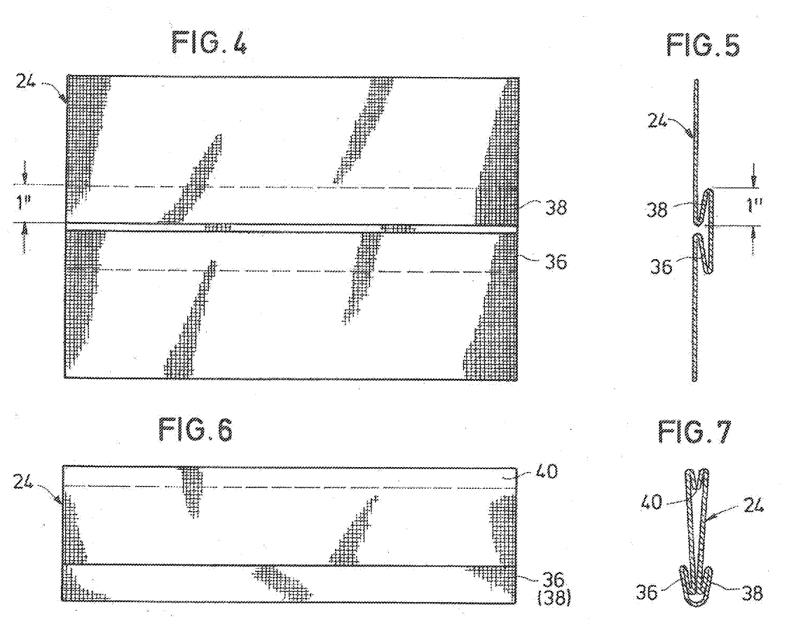

The five layers 24 are placed on top of each other and initially folded as shown in FIGS. 4 and 5. The folds 36 and 38 of the five layers 24 are approximately 1 inch wide. The folds 36 and 38 as shown in FIGS. 4 and 5 are the first folds that are made to the five layers 24.

In FIGS. 6 and 7, the five layers 24 are folded again with second folds to form the configuration as shown in FIGS. 6 and 7. An outer fold 40 is provided in the five layers 24.

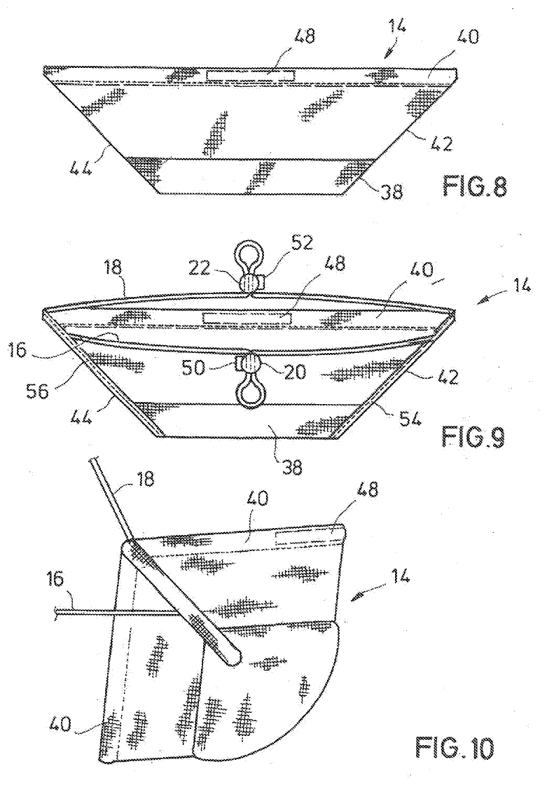

After folding as shown in FIGS. 6 and 7, corners are cut off with 45 degree cuts 42 and 44 as shown in FIG. 8. The facial covering portion 14 as shown in FIG. 8 has not yet been sewn together. In FIG. 9 the 45 degree cuts 42 and 44 are sewn together covering the 45 degree cuts 42 and 44 with borders 54 and 56.

Outer fold 40 is sewn down on both sides, but the top outer fold 40 has a flexible memory strip 48 therein. The flexible memory strip 48 can be a thin aluminum strip that is flexible, but tends to hold its last position.

When sewing together the facial covering portion 14 as shown in FIG. 9, bungee cords 16 and 18 are attached to the facial covering portion 14. By adjustment of cord locks 20 and 22 on bungee cords 16 and 18, respectively, (See FIG. 1), the tightness of the facial covering portion 14 is adjusted.

On either end of the flexible memory strip 48, the outer fold 40 is stitched so that flexible memory strip 48 is securely located within the center of the outer fold 40.

After the face mask 12 is constructed as described in conjunction with FIGS. 4 through 10, the facial portion 14 is secured to the wearer's face as shown in FIGS. 1 and 2. By adjusting the cord locks 20 and 22 on bungee cords 16 and 18, respectively, the tightness of the facial portion 14 is adjusted. By squeezing the flexible memory strip 48 onto the wearer's nose, the upper portion of the facial covering portion is secured against the bridge of the wearer's nose to prevent air flow there around.

By expanding the folds 36 and 38, a pocket is formed in the front of the face covering portion 14 for a good exchange of air during breathing. This prevents carbon dioxide buildup which causes headaches, dizziness or even passing out by the wearer due to too much carbon dioxide.

By use of the five layers 24, a filtration efficiency that exceeds even the maximum filtration by N95 masks is exceeded. By pressing the buttons 50 and 52 on the cord locks 20 and 22, respectfully, the tightness of the bungee cords 16 and 18 can be adjusted, which in turn adjusts the tightness at the facial covering portion 14 of the face mask 12.

By use of the respirator face mask as described herein above, it passes all of the normal tests that an N95 mask should pass as required by the American Society for Testing and Materials (ASTM).

1. A method of making a face mask for shielding a wearer against airborne diseases, comprising of the following steps:
placing five layers of approximately 12″ by 12″ filter material on top of each other;
first folding said five layers along a center line to form a rectangle with two approximately 1″ expansion folds adjacent said center line;
second folding outer edges of said five layers to create an upper outer fold and a lower outer fold;
cutting off corners along said center line of said rectangle at approximately 45 degrees, to give an angled cut;
first sewing a flexible memory strip in a center of said upper outer fold to form an upper seam;
second sewing said lower outer fold to form a lower seam;
third sewing said angled cuts to maintain said five layers with said expansion folds;
first attaching during said third sewing step, a shorter of the two elastic strips on either end thereof to opposing sides of said angled cuts to pull said face mask into a nose area of said wearer; and
second attaching during said third sewing step a longer of two elastic strips on either end thereof to opposing sides of said angled cut to pull said face mask under a chin of said wearer.

2. The method of making a face mask a recited in claim 1 wherein the two elastic strips are bungee cords with cord locks, said cord locks providing a means for adjusting tension of said bungee cords to pull said face mask into said wearer.

3. The method of making a face mask as recited in claim 2 said five layers includes layers of (a) surgical drape, (b) synthetic filtration media with BFE-95 or above rating, and (c) synthetic filtration media with MERV-13 or greater value.

4. The method of making a face mask as recited in claim 3 wherein said five layers are in order as follows:
a) surgical drape;
b) synthetic filtration media with BFE-95 or greater; and
c) synthetic filtration media with MERV-13 or greater;
d) synthetic filtration media with BFE-95 or greater; and
e) synthetic filtration media with BFE-95 or greater; and
f) surgical drape

5. The method of making a face mask as recited in claim 4 include an additional step of measuring distance from cheek-to-cheek before said cutting step to insure proper size of said face mask.

6. A face mask to protect a wearer from airborne contaminants comprising:
a face covering portion; and
attaching elastic strips;
said face covering portion having at least five layers;
a first layer being a first woven cotton fabric such as a first surgical drape;
a second layer being a first synthetic filtration media with BFE-95 or above rating;
a third layer being a second synthetic filtration media with MERV-13 or greater value;
a fourth layer being a third synthetic filtration media with BFE-95 or above rating;
a fifth layer being a second woven cotton fabric such as a second surgical drape;
a center fold of said five layers being along a center line;
two pocket folds of said five layers adjacent said center line;
two edge folds of said five layers to make an upper outer fold and a lower outer fold;
an approximate 45 degree cut of corners of said five layers along said center line;
a flexible memory strip being sewn into a center of said upper center fold;
a shorter of said elastic strips and a longer of said elastic strips being attached to sides of said five layers when said five layers sewn together so that (a) said shorter of said elastic strips pulling said face mask into said wearer's nose and (b) said longer of said elastic strips pulling said face mask into said wearer's chin; and
binding on each end of said five layers over said approximate 45 degree cut

7. The face mask to protect a wearer from airborne contaminants as recited in claim 6 wherein said elastic strips are bungee cords with cord locks thereon, said cord locks being adjustable to control tension provided by said bungee cords.

8. The face mask to protect a wearer from airborne contaminants as recited in claim 7 wherein said two pocket folds are each approximately one inch wide.

9. The face mask to protect a wearer from airborne contaminants as recited in claim 8 wherein said flexible memory strip is made from a thin strip of aluminum.
